(19) United States
(12) Patent Application Publication
(10) Pub. No.: US 2025/0360470 A1
(43) Pub. Date: Nov. 27, 2025

(54) MULTI-GAP VALVE AND HOMOGENIZING APPARATUS COMPRISING SAID MULTI-GAP VALVE

(71) Applicant: GEA MECHANICAL EQUIPMENT ITALIA S.p.A., PARMA (IT)

(72) Inventors: Pierluigi Magnani, Parma (IT); Massimiliano Benassi, Fornovo di Taro (Parma) (IT); Michele Madureri, Parma (IT); Michael Jarchau, Lübeck (IT)

(73) Assignee: GEA MECHANICAL EQUIPMENT ITALIA S.p.A., PARMA (IT)

(21) Appl. No.: 18/874,338

(22) PCT Filed: Mar. 22, 2023
(86) PCT No.: PCT/IB2023/052821

§ 371 Date: Dec. 12, 2024

(30) Foreign Application Priority Data
Jan. 23, 2023 (IT) 102023000000933

(51) Int. Cl. B01F 25/00; B01F 25/441; B01F 25/442

(52) U.S. Cl. CPC B01F 25/1051; B01F 25/4413; B01F 25/4422

(57) ABSTRACT

A multi-gap valve including:
a fluid inlet and a fluid outlet;
a cone having an inner channel developing along an axial direction and having through openings emerging in the inner channel, the inner channel being in fluid communication with the fluid inlet;
a sleeve arranged coaxially and external to the cone;
a plurality of gaps formed between the cone and the sleeve, the sleeve and said cone being axially adjustable relative to one another so as to vary the dimension of the gaps;
an annular chamber obtained between the sleeve and an inner surface of the housing and being in fluid communication with the fluid outlet;
   wherein the fluid inlet is axially aligned with the channel and the fluid outlet is misaligned with respect to the axial direction of said channel.

### TECHNICAL FIELD

The present invention relates to a multi-gap valve and a homogenizing apparatus comprising said multi-gap valve.

The invention proposed here is used in the food industry, in particular in the dairy sector, or in the chemical, pharmaceutical or cosmetic industry. The invention can also be used in manufacturing areas where homogenization is a step of the production process.

Consider, for example, the production of carbon-based nanostructured materials, such as graphene and carbon nanotubes or cellular breakdown of yeasts, algae, or microorganisms for the production of intracellular material.

### BACKGROUND ART

As it is well-known, an apparatus for homogenising fluids crushes the particles, reducing their dimensions to a minimum and make the dimensions of the particles uniform, thus reducing variation of distribution of the dimensions of the particles.

Said homogenising apparatus, also in the different embodiments so far known, comprises a high-pressure pump and a homogenising valve. The homogenising valve comprises a first chamber receiving the fluid at high pressure from the pump delivery and a second chamber capable of supplying outgoing homogenised fluid at low pressure. The homogenising action is obtained by forcing the fluid to pass through an interspace or gap with reduced dimensions afforded between the first and the second chamber. The gap is defined by a passage head integrally joined to the valve body and by an impact head axially mobile with respect to the passage head.

The fluid coming from the inlet presses on a surface of the impact head exerting on it a pressure which tends to widen the gap.

A pusher capable of contrasting the pressure of the fluid in an axial direction is applied to the impact head. The dimension of the gap is controlled by acting directly on the pusher as a function of the valve flow rate and pressure operating values.

As already indicated above, the fluid loses pressure by passing through the gap and is simultaneously accelerated, thus allowing fragmentation of the particles in suspension.

The gap height depends on the volume flow of the process fluids and should remain as small as possible in order to achieve the desired properties. For this reason, so-called multi-gap valves are used for larger volume flows, in which the total flow rate is divided in parallel on single gaps of small height, which are formed by several valve discs.

This type of valve has been known for over 40 years, as disclosed for example in EP 0034675.

Valves suitable for this purpose are disclosed, inter alia, in U.S. Pat. No. 5,749,650 A, WO 01/03818 A1 and WO 01/03819 A1. In these constructions, a plurality of annular valve discs is stacked and configured in such a way that a gap is formed between two valve discs lying on top of one another.

Another multi-gap valve is proposed in document EP 2237658 B1, in which a plurality of valve elements is stacked and define a central volume having an internal threaded surface interlocking a threaded rod.

During the functioning of the valve, the volume flow of the fluid flows from the fluid inlet centrally in the valve discs and flows radially through the gaps, so as to divide it into radially flowing single volume flows. These are then deflected and brought together again and expanded to a back pressure through a second valve.

From documents WO 92/16288 A1 and U.S. Pat. No. 1,483,742 A valves are known comprising a tapering sleeve and a cone mounted within the sleeve and having a tapering profile with the same inclination of the sleeve.

The gaps are formed between the sleeve and the cone, which are mutually adjustable so as to adjust the gap height.

However, the known valves are afflicted with considerable disadvantages both in terms of their construction and in terms of their operation.

The valve discs must each be made of a hard, wear-resistant, rust-free material, which is associated with high costs for material procurement and processing.

High costs also result from the fact that spring elements are provided for centering the valve discs. This requires a correspondingly large radial installation space, which leads to an overall size of the valve which is contrary to the requirements for a dimensionally optimized spatial shape.

Furthermore, the cleaning ability of the valve is limited by the installation space required for the springs, which is of great disadvantage for use for example in the food industry, since a so-called CIP cleaning (CIP=Cleaning In Place) is required without dismantling the components.

The respective gap with a given depth between the valve discs can only be introduced with a correspondingly great grinding effort in the manufacture of the valve discs.

In addition, the adaptation of the valves of conventional design creates problems when coordinating the gap height with the volume flow at a given homogenizing pressure. The gap height is determined by a fixed distance, incorporated by grinding, between the contact surfaces and the valve surface crossed by the flow.

The required sum of the gap areas crossed by the flow is predetermined at a given process pressure. If the number of discs is an integer, an adaptation is therefore necessary in most cases in order to achieve the exact pressure. This is done by deforming the upper discs by means of excess actuating force. This problem occurs particularly strongly when variable, in particular very different, volume flows occur during operation. As a result, the gap heights are no longer constant, but rather can be smaller or even completely closed in the upper area due to deflection.

Since the gap height has an influence on the product quality, it is no longer constant for each gap, which in total can negatively affect the homogeneous distribution, which is contrary to the purpose of the process and the quality requirement.

Regardless of this, the functional reliability of this valve is not guaranteed, because due to the large, pressurized surfaces of the valve discs, large actuating forces are required, which result in a large excess of force if process-related faults, for example due to air bubbles in the flow, its brief interruption, e.g., by switching processes occur. This excess force leads to high bending stress, especially on the upper valve discs towards the fluid inlet, which can lead to their breakage.

In the case of the valves according to the state of the art, the actuating forces are generated predominantly in a force-controlled manner, which is to say hydraulically, in order to apply the necessary high forces. The energy source required therefor is usually not part of the valve installation, so that a corresponding unit must be installed and operated, which is also associated with increased investment and operating costs.

Another issue of prior art solutions is linked to pressure peaks that may lead to process malfunction and cracking of high-pressure components.

Indeed, transient zero flow conditions may cause a complete temporary closure of the homogenizing gap. If affected pump cylinder changes from discharge to suction stroke again, the unaffected cylinders take over and full flow restarts again pumping against the closed homogenizing valve.

This causes pressure peaks up to over two times the nominal pressure.

In this context, the object of the present invention is to provide a multi-gap valve and a homogenizing apparatus, which overcome the problems of the prior art cited above.

### DISCLOSURE OF THE INVENTION

The object of the present invention is to further develop a multi-gap valve that it is structurally simpler and more cost-effective to manufacture, and whose functional reliability is improved.

Another object of the present invention is to propose a multi-gap valve which achieves a more precise setting of the gaps over the prior art.

Another object of the present invention is to propose a multi-gap valve that is less likely to show malfunctions and wear/cracking of high-pressure components, in particular due to zero gap situations.

Another object of the present invention is to propose a multi-gap valve that is easier to be cleaned, in particular suitable for undergoing CIP cycles.

The stated technical task and specified aims are substantially achieved by a multi-gap valve comprising:
a housing;
a fluid inlet for fluid at high pressure;
a fluid outlet for homogenized fluid at low pressure;
a cone having an inner channel developing along an axial direction and having through openings emerging in the inner channel, said inner channel being in fluid communication with the fluid inlet;
a sleeve arranged coaxially and external to the cone, said sleeve and said cone being located inside the housing, the sleeve having an inner surface tapering from the fluid inlet along the axial direction and the cone having the same inclination as the inner surface of the sleeve;
a plurality of gaps formed between the cone and the sleeve, said sleeve, and said cone being axially adjustable relative to one another so as to vary the dimension of the gaps;
an annular chamber obtained between the sleeve and an inner surface of the housing and being in fluid communication with the fluid outlet, said sleeve having through holes towards the annular chamber;

wherein the fluid inlet is axially aligned with the channel and the fluid outlet is misaligned with respect to the axial direction of said channel.

In accordance with an aspect of the invention, the fluid outlet is angled with respect to the axial direction of the channel.

In accordance with one embodiment of the invention, the fluid outlet is orthogonal to the axial direction of the channel.

In accordance with an aspect of the invention, the multi-gap valve further comprises a stop element axially arranged at an end of the cone that is opposed to the fluid inlet, said stop element being integrally connected to the sleeve.

In particular, the stop element is interposed between the cone and a pneumatic cylinder of the multi-gap valve.

According to one embodiment of the invention, the sleeve is composed of a plurality of pieces joined together.

According to one embodiment of the invention, the cone is composed of a plurality of pieces joined together.

According to one embodiment of the invention, the sleeve is a monolithic piece, and the cone is a monolithic piece.

According to one embodiment of the invention, the through holes are offset in the axial direction with respect to the through openings.

According to one aspect of the invention, the through openings and the through holes are radially aligned.

According to one aspect of the invention, the through openings and/or the through holes on their mutually facing sides open into circumferential grooves that are wider in cross section.

Preferably, the through openings and/or the through holes are each arranged at the same distance from one another.

Preferably, an angle of inclination of the inner surface of the sleeve is greater than an angle for self-locking.

The stated technical task and specified aims are substantially achieved by a homogenizing apparatus comprising:
at least one multi-gap valve according to the present invention;
a high-pressure pump for delivering fluid to the fluid inlet of the multi-gap valve.

According to one embodiment of the invention, the homogenizing apparatus comprises a plurality of multi-gap valves according to the present invention, wherein said multi-gap valves are arranged in a cascade.

### BRIEF DESCRIPTION OF DRAWINGS

Further characteristics and advantages of the present invention will more fully emerge from the non-limiting description of a preferred but not exclusive embodiment of a multi-gap valve and a homogenizing apparatus, as illustrated in the accompanying drawings in which:

FIGS. 1a and 1b illustrate a multi-gap valve, according to two different embodiments of the present invention, in a longitudinal cross-section view;

FIG. 2 illustrates an enlarged section of the multi-gap valve according to the marking X in FIG. 1a;

FIG. 3 illustrates a homogenizing apparatus, according to present invention, in a perspective view;

FIG. 4 is an enlarged cross-section of the portion according to the marking Y of FIG. 3, where the multi-gap valve is identified.

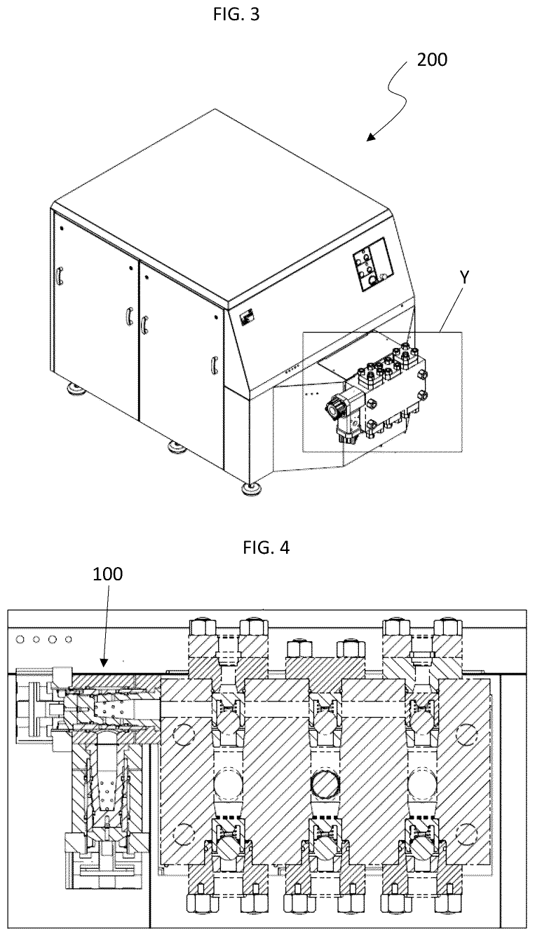

### DETAILED DESCRIPTION OF PREFERRED EMBODIMENTS OF THE INVENTION

With reference to the figures, number 100 indicates a multi-gap valve.

The multi-gap valve 100 comprises a housing 1, a fluid inlet 5 for fluid at high pressure, and a fluid outlet 6 for homogenized fluid at low pressure.

A rotationally symmetrical valve body 2 is arranged inside the housing 1.

The valve body 2 comprises of a first valve element 3 and a second valve element 4 that is mounted inside the first valve element 3.

The first valve element 3 is shaped as a sleeve.

In this context, “sleeve” and “first valve element” indicate the same component and are identified with number 3.

The second valve element 4 is shaped as a cone.

In this context, “cone” and “second valve element” indicate the same component and are identified with number 4.

The cone 4 has an inner channel 7 developing along an axial direction AA.

The inner channel 7 is in fluid communication with the fluid inlet 5.

In particular, the cone 4 has through openings 9 emerging in the inner channel 7.

Preferably, the inner channel 7 is centrally obtained within the cone 4.

Thus, the axial direction AA of the inner channel 7 coincides with a longitudinal axis of the cone 4. In this context, they are both indicated with AA.

According to an aspect of the invention, the sleeve 3 is mounted coaxially and external to the cone 4.

The sleeve 3 has an inner surface tapering from the fluid inlet 5 along the axial direction AA.

The cone 4 has the same inclination as the inner surface of the sleeve 3.

The angle of inclination α, with respect to the longitudinal axis AA of the cone 4, is selected so that it is greater than the angle for self-locking.

In particular, the sleeve 3 is mounted on a cylindrical end area of the cone 4 with its inner surface which is likewise cylindrical in this area.

The cone 4 is located inside the sleeve 3 and a plurality of gaps 14 is obtained between the cone 4 and the sleeve 3.

The gaps 14 are circumferential gaps.

According to one embodiment, the sleeve 3 is a monolithic piece and the cone 4 is a monolithic piece.

In this context, the expression “monolithic” means that the piece is made of a single block, which cannot be dismantled.

According to another embodiment, the sleeve 3 and the cone 4 are both composed of a plurality of pieces joined together.

For example, the sleeve 3 and the cone 4 can be designed to have some pieces made of a stronger material. Usually, the pieces made of a stronger material are the most critical ones.

For example, the critical pieces are made of tungsten carbide, while the other pieces are made of steel, which is less strong than tungsten carbide.

In one example, the sleeve 3 comprises a plurality of steel pieces and at least one piece made of tungsten carbide.

Analogously, in one embodiment the cone 4 comprises a plurality of steel pieces and at least one piece made of tungsten carbide.

According to other embodiments, one of the two valve elements 3, 4 is monolithic, whereas the other is composed of a plurality of pieces joined together.

In accordance with an aspect of the invention, the fluid inlet 5 is axially aligned with the channel 7. In particular, the fluid inlet 5 is coaxial with the channel 7.

The fluid outlet 6 is misaligned with respect to the axial direction AA of the channel 7.

According to the illustrated embodiment, the fluid outlet 6 is angled with respect to the axial direction AA of the channel 7.

Preferably, the fluid outlet 6 is right-angled, that means orthogonal to the axial direction AA of the channel 7.

This results in a flexible, compact, and less expensive installation of the multi-gap valve 100.

Starting from the channel 7, radially oriented through openings 9 are provided in the wall of the cone 4.

Each through opening 9 opens into a corresponding circumferential groove 13 on the side facing the inner surface of the sleeve 3.

In accordance with one embodiment, the circumferential grooves 13 are greater in width than the diameter of the corresponding through openings 9.

Through holes 10 comparable in terms of their conformation are incorporated in the wall of the sleeve 3.

Each through hole 10 opens into a corresponding circumferential groove 13 on the side facing the cone 4.

In accordance with one embodiment, the circumferential grooves 13 of are greater in width than the diameter of the corresponding through holes 10.

In accordance with an aspect of the invention, the through holes 10 are offset in the axial direction of the valve body 2 with respect to the through openings 9 of the cone 4.

In practice, the through holes 10 are offset in the axial direction AA with respect to the through openings 9 of the cone 4.

Preferably, both the through holes 10 and the through openings 9 are each arranged at the same distance in the axial and in the circumferential direction.

Opposite, that is, towards the inner side of the housing 1, the through holes 10 open into an annular chamber 8 formed between the inner side of the housing 1 and the sleeve 3.

In particular, the annular chamber 8 is in communication in a fluid-open manner with the fluid outlet 6.

Advantageously, the sleeve 3 and the cone 4 are mutually movable so as to adjust the dimension of the gaps 14.

In particular, the sleeve 3 and the cone 4 are axially slidable relative to one another so as to adjust the height of the gaps 14.

In particular, the cone 4 is fixed and the sleeve 3 is movable.

According to an aspect of the invention, the multi-gap valve 100 comprises a first high-pressure gasket 17 arranged between the sleeve 3 and the cone 4.

Preferably, the valve comprises also a second high-pressure gasket 18 arranged between the sleeve 3 and the cone 4.

High-pressure gaskets 17,18 seal the high-pressure side between the sleeve 3 and the cone 4 in a respective cylindrical section.

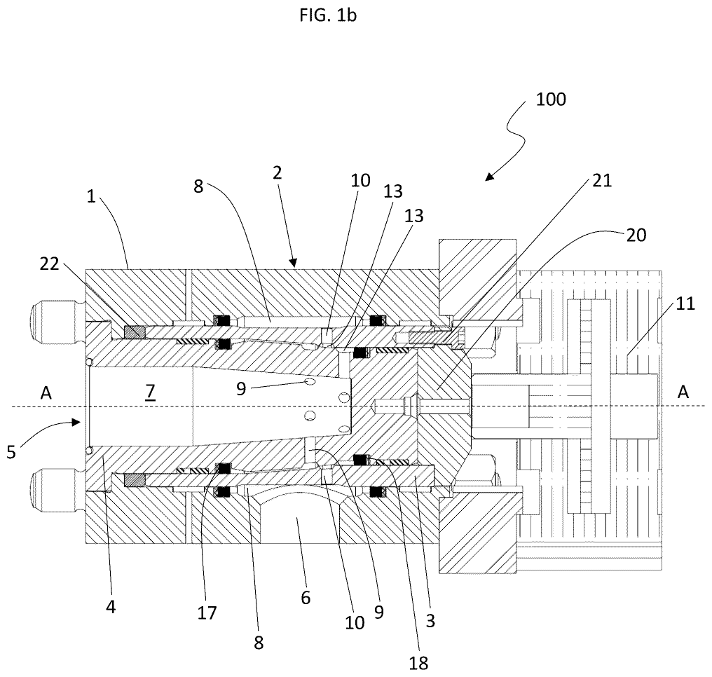

In FIG. 2, in an enlarged illustration, a detail of a region is shown in which the mutually facing inclined surfaces of the sleeve 3 and of the cone 4 form circumferential gaps 14. Their contours are conformed as knife edges 15. An impact effect of the exit jets running in opposite directions in the circumferential groove 13 can be seen from the arrow indications.

The fluid is fed under pressure to the fluid inlet 5, the channel 7 of the cone 4 and the through openings 9, thus arriving in the gaps 14 where the fluid is further pressed via the through holes 10 in the annular chamber 8, from where the fluid is guided through the fluid outlet 6.

Advantageously, the multi-gap valve 100 comprises a stop element 20 which is axially arranged at one end of the cone 4 which is opposite to the fluid inlet 5.

In particular, the stop element 20 is interposed between the cone 4 and a pneumatic cylinder 11 that is operatively active on the sleeve 3.

Thanks to the pneumatic cylinder 11 an axial relative movement between the sleeve 3 and the cone 4 is possible so as to achieve an exact height of the circumferential gaps 14 through which the fluid can be pressed.

Preferably, the pneumatic cylinder 11 is operatively active on the sleeve 3 to slide it along a direction that is parallel to the axial direction AA of the inner channel 7.

The stop element 20 is integrally connected to the sleeve 3.

In particular, the stop element 20 is mounted on the sleeve 3 by means of pins or screws 21.

Since the sleeve 3 is the movable part, the stop element 20 moves integrally with the sleeve 3.

The stop element 20 provides an additional safety feature, preventing “zero gap” situations.

As a matter of fact, the stop element 20 is designed to limit the stroke of the sleeve 3 so as to avoid the abutment of the knife edges 15 and the inner surface of the cone 4. Therefore, the gaps 14 may be created.

Furthermore, thanks to the stop element 20 the sleeve 3 is prevented from being misaligned due to an excessive pressure exerted by the pneumatic cylinder 11.

The stop element 20 can be easily removed from its seat without removing the sleeve 3.

The position of the stop element 20 at one end of the cone 4 contributes to the compactness of the design.

In particular, the sleeve 3 has an inner surface tapering from the fluid inlet 5 to the stop element 20 along the axial direction AA.

According to an embodiment of the invention, the multi-gap valve 100 comprises a further stop element.

For example, the further stop element can be a spacer ring 22 which is arranged in a space obtained between a first end of the sleeve 3 close to the fluid inlet 5, the housing 1 and an outer surface of the cone 4.

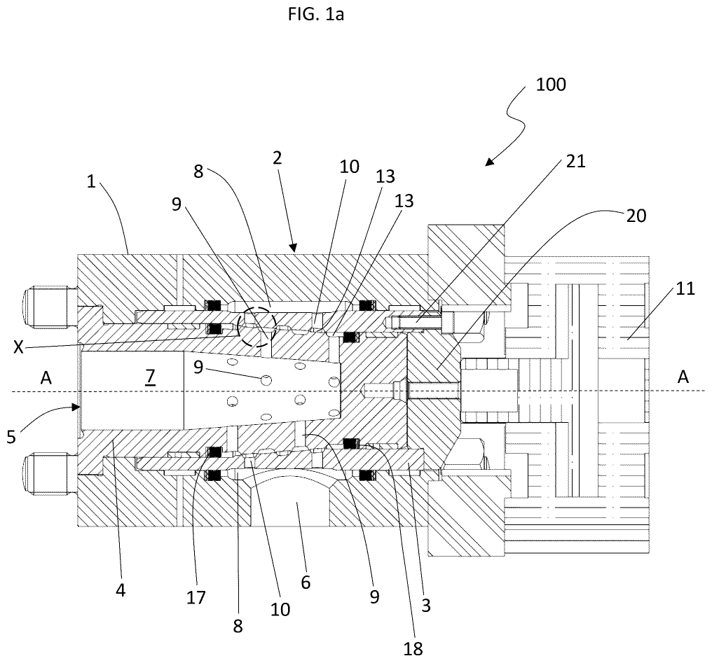

In particular, the spacer ring 22 abuts the housing 1, the first end of the sleeve 3 and the outer surface of the cone 4. This is shown in FIG. 1b.

In this embodiment, the stop element 20 and the spacer ring 22 are configured to provide two different levels of safety.

The spacer ring 22 indeed provides a lower level of safety since it is farther from the pressure side, whereas the stop element 20 provides a higher level of safety since it is close to the pressure side.

Two multi-gap valves 100 according to the claimed invention may also be arranged in a cascade.

A modular system of two or more multi-gap valves 100 is thus enviseageable.

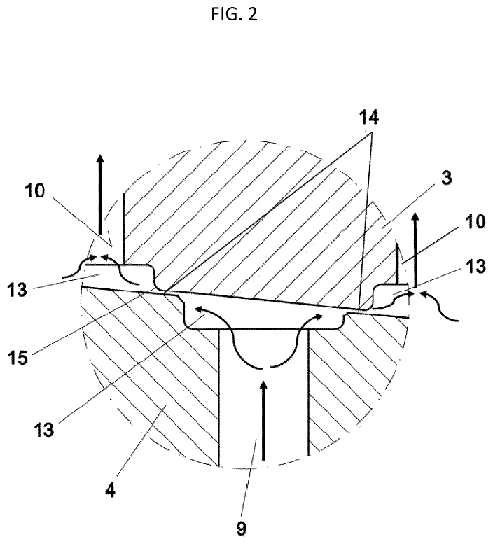

FIG. 3 illustrates a homogenizing apparatus 200 comprising:
at least one multi-gap valve 100 according to the invention;
a high-pressure pump for delivering fluid to the fluid inlet 5 of the multi-gap valve 100.

As said, the homogenizing apparatus 200 may comprise a plurality of multi-gap valves 100 arranged in a cascade.

The homogenizing apparatus 200 may comprise also valves of different types which are combined with one or more multi-gap valves 100 according to the invention.

The characteristics of a multi-gap valve according to the present invention, are clear, as are the advantages.

In particular, thanks to the angled arrangement of the fluid outlet with respect to the fluid inlet, the multi-gap valve is more compact and flexible than prior art solutions.

In addition, the stop element prevents “zero gap” situation and associated shock loadings.

In the embodiment comprising the stop element and the spacer ring there are provided two different levels of safety.

1. A multi-gap valve (100) comprising:
a housing (1);
a fluid inlet (5) for fluid at high pressure;
a fluid outlet (6) for homogenized fluid at low pressure;
a cone (4) having an inner channel (7) developing along an axial direction (AA) and having through openings (9) emerging in the inner channel (7), said inner channel (7) being in fluid communication with the fluid inlet (5), said inner channel (7) being centrally obtained within the cone (4), thereby the axial direction (AA) of the inner channel (7) coincides with a longitudinal axis of the cone (4);
a sleeve (3) arranged coaxially and external to the cone (4), said sleeve (3) and said cone (4) being located inside the housing (1), the sleeve (3) having an inner surface tapering from the fluid inlet (5) along the axial direction (AA) and the cone (4) having the same inclination as the inner surface of the sleeve (3);
a plurality of gaps (14) formed between the cone (4) and the sleeve (3), said sleeve (3) and said cone (4) being axially adjustable relative to one another so as to vary the dimension of the gaps (14);
an annular chamber (8) obtained between the sleeve (3) and an inner surface of the housing (1) and being in fluid communication with the fluid outlet (6), said sleeve (3) having through holes (10) towards the annular chamber (8),
each through opening (9) opening into a corresponding circumferential groove (13) on a side facing the inner surface of the sleeve (3), each through hole (10) opening into a corresponding circumferential groove (13) on a side facing the cone (4),
wherein the fluid inlet (5) is axially aligned with the channel (7) and the fluid outlet (6) is misaligned with respect to the axial direction (AA) of said channel (7).

2. The multi-gap valve (100) according to claim 1, wherein the fluid outlet (6) is angled with respect to the axial direction (AA) of the channel (7).

3. The multi-gap valve (100) according to claim 2, wherein the fluid outlet (6) is orthogonal to the axial direction (AA) of the channel (7).

4. The multi-gap valve (100) according to claim 1, further comprising a stop element (20) axially arranged at an end of the cone (4) that is opposed to the fluid inlet (5), said stop element (20) being integrally connected to the sleeve (3).

5. The multi-gap valve (100) according to claim 4, wherein said stop element (20) is interposed between the cone (4) and a pneumatic cylinder (11) of the multi-gap valve (100).

6. The multi-gap valve (100) according to claim 1, wherein the sleeve (3) is composed of a plurality of pieces joined together.

7. The multi-gap valve (100) according claim 1, wherein the cone (4) is composed of a plurality of pieces joined together.

8. The multi-gap valve (100) according to claim 1, wherein the sleeve (3) is a monolithic piece, and the cone (4) is a monolithic piece.

9. The multi-gap valve (100) according to any of the preceding claim 1, wherein the through holes (10) are offset in the axial direction (AA) with respect to the through openings (9).

10. The multi-gap valve (100) according to claim 1, wherein the through openings (9) and the through holes (10) are radially aligned.

11. The multi-gap valve (100) according to claim 1, wherein the through openings (9) and/or the through holes (10) on their mutually facing sides open into circumferential grooves (13) that are wider in cross section.

12. The multi-gap valve (100) according to claim 1, wherein the through openings (9) and/or the through holes (10) are each arranged at the same distance from one another.

13. A homogenizing apparatus (200) comprising:
at least one multi-gap valve (100) according to claim 1;
a high-pressure pump for delivering fluid to the fluid inlet (5) of the multi-gap valve (100).

14. The homogenizing apparatus (200) according to claim 13, comprising a plurality of multi-gap valves (100) according to any one of claims 1 to 12, wherein said multi-gap valves (100) are arranged in a cascade.

15. (canceled)

16. The multi-gap valve (100) according to claim 2, further comprising a stop element (20) axially arranged at an end of the cone (4) that is opposed to the fluid inlet (5), said stop element (20) being integrally connected to the sleeve (3).

17. The multi-gap valve (100) according to claim 2, wherein the sleeve (3) or the core (4) is composed of a plurality of pieces joined together.

18. The multi-gap valve (100) according to claim 3, wherein the sleeve (3) or the core (4) is composed of a plurality of pieces joined together.

19. The multi-gap valve (100) according to claim 2, wherein the sleeve (3) is a monolithic piece, and the cone (4) is a monolithic piece; or wherein the through holes (10) are offset in the axial direction (AA) with respect to the through openings (9).

20. The multi-gap valve (100) according to claim 2, wherein the through openings (9) and the through holes (10) are radially aligned; wherein the through openings (9) and/or the through holes (10) on their mutually facing sides open into circumferential grooves (13) that are wider in cross section; or wherein the through openings (9) and/or the through holes (10) are each arranged at the same distance from one another.
